(19) United States
(12) Patent Application Publication
(10) Pub. No.: US 2024/0202605 A1
(43) Pub. Date: Jun. 20, 2024

(54) PHYSICIAN SUBSPECIALTY TAXONOMY USING DATA-DRIVEN MODELS

(71) Applicant: NAVHEALTH, INC., Arlington, VA (US)

(72) Inventors: Christopher LESTER, Arlington, VA (US); Christopher FREYDER, Arlington, VA (US); Morgan MENDIS, Arlington, VA (US); Yuxiao HUANG, Arlington, VA (US)

(73) Assignee: NAVHEALTH, INC., Arlington, VA (US)

(21) Appl. No.: 18/572,975

(22) PCT Filed: Jun. 24, 2022
(86) PCT No.: PCT/US2022/034930

§ 371 Date: Dec. 21, 2023

Related U.S. Application Data
(60) Provisional application No. 63/214,882, filed on Jun. 25, 2021.

(51) Int. Cl. G06N 20/20; G06N 3/08

(52) U.S. Cl. CPC G06N 20/20; G06N 3/08

(57) ABSTRACT

A method includes receiving data associated with a plurality of physicians, extracting features from the data to determine a plurality of training examples, each training example being associated with a different physician, determining ground truth labels for one or more of the training examples to generate a plurality of labeled training examples, each ground truth label comprising a taxonomy associated with a physician, segregating the plurality of labeled training examples into training data, validation data, and test data, training a machine learning model to predict a taxonomy associated with a physician based on the training data, tuning hyperparameters of the model based on the validation data, and interpreting the model on both a taxonomy and physician level.

### CROSS-REFERENCE TO RELATED APPLICATION

This application claims priority to U.S. Provisional Application No. 63/214,882 filed on Jun. 25, 2021, which is incorporated herein by reference in its entirety.

### TECHNICAL FIELD

The present specification relates to classification of physicians, and more particularly, to physician subspecialty taxonomy using data-driven models.

### BACKGROUND

Physicians tend to focus their medical practice on certain specialties or sub-specialties in which they have the appropriate training and expertise. In the medical field, a specialty or sub-specialty is often referred to as a taxonomy. When a physician first enters the medical field, she is required to self-report her taxonomy through the National Plan and Provider Enumeration System (NPPES) maintained by the Centers for Medicare & Medicaid Services (CMS). The NPPES maintains a database of all providers and their taxonomies.

This database may be used in a variety of contexts. For example, an insurance company building a network of providers may decide which providers to include in the network based on this self-reported taxonomy, public facing directories of medical providers may include this information to consumers looking for particular providers, and other physicians or medical facilities may make referrals based on this information.

As a physician advances in her career, she may change the focus of her practice to a different taxonomy. However, physicians may not readily report such a change in taxonomy. As such, the NPPES database, and other systems that rely on this database, may become outdated over time. Accordingly, a need exists for a method of maintaining accurate physician taxonomy data.

### SUMMARY

In an embodiment, a method may include receiving data associated with a plurality of physicians, extracting features from the data to determine a plurality of training examples, determining ground truth labels for one or more of the training examples to generate a plurality of labeled training examples, segregating the plurality of labeled training examples into training data, validation data, and test data, training a machine learning model to predict a taxonomy associated with a physician based on the training data, tuning hyperparameters of the model based on the validation data, and interpreting the model on both a taxonomy and physician level. Each training example may be associated with a different physician. Each ground truth label may include a taxonomy associated with a physician.

In another embodiment, an apparatus may include a controller programmed to receive data associated with a plurality of physicians, extract features from the data to determine a plurality of training examples, determine ground truth labels for one or more of the training examples to generate a plurality of labeled training examples, segregate the plurality of labeled training examples into training data, validation data, and test data, train a machine learning model to predict a taxonomy associated with a physician based on the training data, and tune hyperparameters of the model based on the validation data. Each training example may be associated with a different physician. Each ground truth label may include a taxonomy associated with a physician.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example computing device, according to one or more embodiments shown and described herein;

FIG. 2 schematically depicts a plurality of memory modules of the computing device of FIG. 1, according to one or more embodiments shown and described herein;

FIG. 3 depicts an example of feature value contributions to a taxonomy, according to one or more embodiments shown and described herein;

FIG. 4 schematically depicts an example of features values associated with a particular physician that contribute to a taxonomy assigned to the physician, according to one or more embodiments shown and described herein;

FIG. 5 depicts a flowchart of an example method for training a model to classify physician taxonomies, according to one or more embodiments shown and described herein; and

FIG. 6 depicts a flowchart of an example method of utilizing a trained model to classify a physician into a taxonomy, according to one or more embodiments shown and described herein.

### DETAILED DESCRIPTION

The embodiments disclosed herein describe systems and methods for classifying physicians into subspecialty taxonomies using data-driven methods. Physicians must record their specialty or specialties through NPPES in order to receive a National Provider Identifier (NPI) and register to bill medical claims. However, the specialties recorded in NPPES are often overly broad and do not adequately capture the nuance of how physicians focus their practices within specialties and sub-specialties. For example, a physician may self-identify as a cardiologist but may specialize in adult congenital cardiology, cardiac electrophysiology, interventional cardiology, pediatric cardiology, or any number of other sub-specialties. Furthermore, physicians may change or add sub-specialties to their practice over time, and such changes are often not accurately reflected in NPPES.

Moreover, understanding how a physician practices medicine may extend beyond applying clinical specialization labels and may include other information that may be relevant to consumers, such as relevant areas of focus or tags for important physician behaviors and practice patterns. For example, it may be important for a patient to know whether a doctor has experience treating frail patients or is familiar within cutting-edge treatment options in a particular area of specialization.

Accordingly, accurate labeling of taxonomies, indicating how physicians actually practice medicine, is incredibly important, as it may inform decision making for physicians, insurance providers, and patients. For example, insurance providers may desire to build products with networks that adequately serve the needs of their patients, physicians may desire to know where to appropriately send referrals, and patients may desire an easy way to search for the appropriate physicians for specific types of medical care.

There is a variety of publicly and privately available data that provides information about how a physician practices medicine, which may be used to identify a taxonomy for that physician. For example, billing codes of procedures performed by a physician may be used to determine a taxonomy for the physician. However, there are thousands of different billing codes and there may be dozens of potential sub-specialties or taxonomies that may be associated with physicians. As such, the vast amount of data and the complex relationship between procedures performed by physicians, other data associated with physicians, and taxonomies cannot be determined manually or using a naïve computer program.

Accordingly, embodiments disclosed herein solve the technical problem of how to leverage the vast amount of data associated with physicians' medical practices to robustly and accurately determine taxonomies associated with physicians. In embodiments, a rigorous machine learning pipeline is used to determine physician taxonomies, as disclosed herein. The machine learning pipeline disclosed herein includes data preprocessing, model training, hyperparameter tuning, model selection, and validation. Embodiments disclosed herein also provide a method of interpreting model results to indicate why different physicians are classified in a particular manner by the model, thereby establishing trust and accountability for the model.

Systems and methods disclosed herein can be used in a variety of applications. In one example, insurance companies building a network of providers may utilize physician taxonomies determined by the methods of this disclosure in order to ensure that the network includes physician with sufficient coverage of different specialties and sub-specialties. In another example, physicians may be presented with the taxonomies so that appropriate referrals can be made to other physicians. In another example, a consumer facing product may present the taxonomies to consumers who can utilize the taxonomies when selecting a physician for needed medical care.

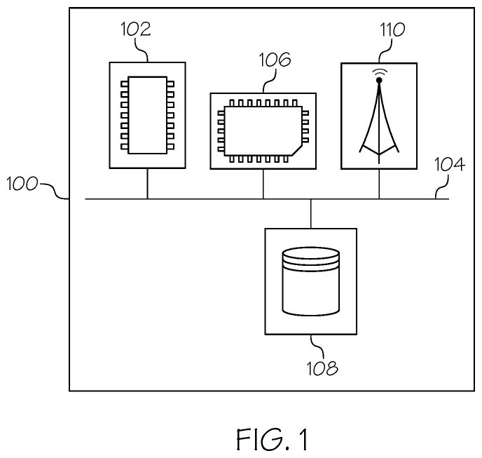

Turning now to the figures, FIG. 1 shows an example computing device 100 that may classify physician taxonomies, according to embodiments described herein. The computing device 100 of FIG. 1 includes one or more processors 102, a communication path 104, one or more memory modules 106, a data storage component 108, and network interface hardware 110, the details of which will be set forth in the following paragraphs.

Each of the one or more processors 102 may be any device capable of executing machine readable and executable instructions. Accordingly, each of the one or more processors 102 may be a controller, an integrated circuit, a microchip, a computer, or any other physical or cloud-based computing device. The algorithms discussed below may be executed by the one or more processors 102. The one or more processors 102 are coupled to a communication path 104 that provides signal interconnectivity between various modules of the computing device 100. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth®, Near Field Communication (NFC) and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

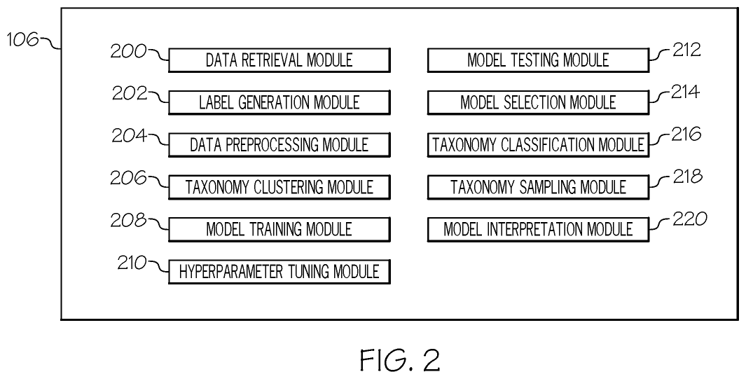

The computing device 100 includes one or more memory modules 106 coupled to the communication path 104. The one or more memory modules 106 may comprise RAM, ROM, flash memories, hard drives, or any device capable of storing machine readable and executable instructions such that the machine readable and executable instructions can be accessed by the one or more processors 102. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 106. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 106 are discussed in more detail below in connection with FIG. 2.

Referring still to FIG. 1, the example computing device 100 includes a data storage component 108. The data storage component 108 may store a variety of data used by the computing device 100, as disclosed herein. For example, the data storage component 108 may store physician data received by the computing device 100. In addition, the computing device 100 may maintain one or more models that may be used to classify physician taxonomies, as disclosed herein. As the models are trained, utilizing the techniques described herein, the learned parameters of the models may be stored by the data storage component 108.

Still referring to FIG. 1, the computing device 100 comprises network interface hardware 110 for communicatively coupling the computing device 100 to external devices. For example, the network interface hardware 110 may communicatively couple the computing device 100 to external servers or databases for receiving physician data. As such, the network interface hardware 110 may send data to and/or receive data from other computing devices. The network interface hardware 110 can be communicatively coupled to the communication path 104 and can be any device capable of transmitting and/or receiving data via a network. Accordingly, the network interface hardware 110 can include a communication transceiver for sending and/or receiving any wired or wireless communication. For example, the network interface hardware 110 may include an antenna, a modem, LAN port, Wi-Fi card, WiMax card, mobile communications hardware, near-field communication hardware, satellite communication hardware and/or any wired or wireless hardware for communicating with other computing devices.

Referring now to FIG. 2, the one or more memory modules 106 include a data retrieval module 200, a label generation module 202, a data preprocessing module 204, a taxonomy clustering module 206, a model training module 208, a hyperparameter tuning module 210, a model testing module 212, a model selection module 214, a taxonomy classification module 216, a taxonomy sampling module 218, and a model interpretation module 220. Each of the data retrieval module 200, the label generation module 202, the data preprocessing module 204, the taxonomy clustering module 206, the model training module 208, the hyperparameter tuning module 210, the model testing module 212, the model selection module 214, the taxonomy classification module 216, the taxonomy sampling module 218, and the model interpretation module 220 may be a program module in the form of operating systems, application program modules, and other program modules stored in one or more memory modules 106. Such a program module may include, but is not limited to, routines, subroutines, programs, objects, components, data structures and the like for performing specific tasks or executing specific data types as will be described below.

The data retrieval module 200 may retrieve data to be utilized by the computing device 100, as described herein. As described herein, the computing device 100 may utilize a variety of data associated with physicians to train a model to classify physician taxonomies. In particular, the computing device 100 may utilize training data comprising data points associated with a plurality of physicians, and a ground truth taxonomy associated with each physician. The computing device 100 may then train the model to predict a taxonomy for a physician based on the training data, as disclosed herein. Accordingly, the data retrieval module 200 may retrieve data associated with physicians as disclosed herein.

Before the model is trained, the data retrieval module 200 may receive training data to be utilized by the computing device 100 to train the model. After the model is trained, the data retrieval module 200 may receive additional training data to refine the training of the module. Additionally, after the model is trained, the data retrieval module 200 may receive data associated with a physician whose taxonomy is unknown. The computing device 100 may then utilize the train model to predict the taxonomy of the physician based on the data. The physician may then be classified into the predicted taxonomy.

The data retrieval module 200 may receive a variety of data associated with physicians. As one example, the data retrieval module 200 may receive medical claims and encounter data associated with physicians. In particular, when a physician performs a medical procedure on a patient, a claim is typically submitted to the patient's insurance company, Medicare, Medicaid, or some other billing agency. A claim typically lists a medical billing code indicating the specific procedure performed by the physician. As such, the data retrieval module 200 may receive data about medical procedures performed by physicians. In some examples, this data may come from the Centers for Medicare & Medicaid Services (CMS). However, in other examples, this data may come from other sources such as other government agencies, insurance companies, hospitals, or commercial entities.

In some examples, the data retrieval module 200 may receive one or more Healthcare Common Procedure Coding System (HCPCS) codes associated with medical procedures performed by one or more physicians. In some examples, the data retrieval module 200 may receive one or more Clinical Classification Software (CCS) codes associated with medical procedures performed by one or more physicians. In some examples, the data retrieval module 200 may receive one or more International Classification of Diseases (ICD-10) codes associated with medical procedures performed by one or more physicians. In other examples, the data retrieval module 200 may receive other types of codes associated with medical procedures performed by one or more physicians. In some examples, the data retrieval module 200 may receive multiple types of codes associated with medical procedures performed by one or more physicians. In embodiments, the data retrieval module 200 may receive data indicating a diagnosis, a procedure performed, as well as information about patient longitudinal history for each medical procedure.

Other data received by the data retrieval module 200 may include relevant experience associated with physicians, such as places they have worked, in what area their residency was in, any fellowships they have completed, organizations they are a member are, how they self-identify their specialties, and the like. As discussed above, this data may be received as training data, to be utilized by the computing device 100 to train the model, or as data from an unknown physician, to be used by the computing device 100 to predict the taxonomy of the physician. In some examples, the data retrieval module 200 may retrieve this type of data by scraping publicly available websites.

Referring still to FIG. 2, the label generation module 202 may generate a label for each training example. As discussed above, the computing device 100 may utilize training data to train a model to predict a taxonomy associated with a physician based on data associated with the physician. In particular, the computing device 100 may train the model utilize supervised learning techniques. That is, the computing device 100 may utilize training data comprising a plurality of training examples, where each training example is associated with a particular physician. The data that comprises a training example may be received by the data retrieval module 200, as discussed above. In addition, in order to use supervised learning, a ground truth label is needed for each training example. In the illustrated example, the ground truth label associated with a training example for a particular comprises a taxonomy associated with the physician. Accordingly, the label generation module 202 may generate labels for a plurality of training examples.

The label generation module 202 may utilize a variety of methods to generate a label for a training example. Certain specialty societies may have precise taxonomy information for their member physicians. As such, in some examples, the label generation module 202 may retrieve a taxonomy for a physician from a specialty society for which the physician is a member. In particular, the label generation module 202 may have a database of such societies that maintain accurate taxonomy information, and may retrieve such data from these societies.

In other examples, a board of experts may be consulted to identify a taxonomy for a physician. For example, the board of experts may be presented with data about a physician that has been retrieved by the data retrieval module 200 and the board may identify a taxonomy for the physician based on the data associated with the physician using their experience and judgment. In some examples, a physician may be asked to validate an assigned taxonomy herself. In other examples, unsupervised learning techniques may be used to generate labels, as discussed below in connection with the taxonomy clustering module 206.

In the illustrated examples, the label generation module 202 assigns a single taxonomy to every physician, using one or more of the techniques described above. However, in other examples, physicians who practice multiple sub-specialties may have multiple taxonomies. In these examples, the label generation module 202 may assign multiple taxonomies to certain physicians.

Referring still to FIG. 2, the data preprocessing module 204 may perform preprocessing of data to be input to the model maintained by the computing device 100, as disclosed herein. In particular, the data preprocessing module 204 may convert the data received by the data retrieval module 200 into features that may be input into the model. For each physician, there may be a large amount of data associated with that physician (e.g., a physician may perform thousands of procedures over her career). As such, it may not be computationally feasible to input all of the data points associated with a physician into the model. In addition, certain data points associated with a physician may not be relevant to predicting a taxonomy, and may even compromise the performance of the model. As such, the data preprocessing module 204 may extract features such that there is a meaningful relationship between the features and the labels generated by the label generation module 202, and such that these relationships are recognized by the model. The features can then be input to the model, as discussed in further detail below.

In embodiments, the model relies primarily on encounter data, as discussed above, which may include a diagnosis, procedure information, and patient information for each billed encounter between a physician and a patient. The model may also utilize other data about a physician such as self-reported taxonomy, as discussed above.

In the illustrated embodiment, the data preprocessing module 204 may count the number of times that a physician has performed a given procedure, based on the data received by the data retrieval module 200. The data preprocessing module 204 may then utilize this number as a feature value to be input to the model. Thus, for each physician for which data is received by the data retrieval module 200, the data preprocessing module 204 may count the number of times that a physician has performed each procedure among all procedures for which data is available. For any procedures that a physician has never performed, the data preprocessing module 204 may use a value of zero for that procedure. In some examples, the data preprocessing module 204 may count the number of times that a physician has performed a procedure during her entire career. In other examples, the data preprocessing module 204 may count the number of times that a physician has performed a procedure during a certain time period (e.g., over the last five years). As such, for each physician for which data is received by the data retrieval module 200, the data preprocessing module 204 may determine a fixed length sequence having a length equal to the total number of possible procedures (e.g., there may be 250 procedures for which data is available), wherein the value for each data point in the sequence is equal to the number of times the physician has performed a particular procedure.

In some examples, the data preprocessing module 204 may determine other features based on the data received by the data retrieval module 200. For example, the data preprocessing module 204 may consider how a physician identifies themselves, with the data preprocessing module 204 generating a 1 for each taxonomy with which the physician identifies, and a 0 for each taxonomy with which the physician does not identify. In some examples, the data preprocessing module 204 may generate other features based on the data received by the data retrieval module 200 such as membership in societies, residency or fellowship history, and the like. For these types of features, which often consist of text, the data preprocessing module 204 may perform natural language processing (e.g., Bidirectional Encoder Representations from Transformers (BERT)) to determine feature values.

For training data, the data preprocessing module 204 may also associate a ground truth taxonomy with each training example. In the illustrated example, the data preprocessing module 204 associates a single ground truth taxonomy with each training example, as discussed above. However, in other examples, the data preprocessing module 204 may associate multiple taxonomies with one or more training examples. In some examples, the data preprocessing module 204 determines a class or specialty associated with each training example (e.g., cardiology), as well as a taxonomy or sub-specialty associated with each training example (e.g., pediatric cardiology). This may allow the model to be operated in two stages, as discussed below, where the first stage predicts a class for the physician, and the second phase predicts a particular taxonomy within the class. This may reduce the feature space and computational resources needed to run the model.

Referring still to FIG. 2, the taxonomy clustering module 206 may utilize unsupervised learning techniques to create additional labeled data, as disclosed herein. As discussed above, the label generation module 202 may determine taxonomy labels for physicians using a variety of techniques such as receiving a label from a trusted specialist organization, or receiving a label from a board of experts or directly from the physician. While this type of label generation may be desirable, it may be difficult and/or time consuming to determine labels this way for a large number of physicians. Accordingly, in some examples, the label generation module 202 may use these techniques to generate labels for a small number of physician training examples, and the taxonomy clustering module 206 may generate additional labels for other training examples, as disclosed herein.

After the label generation module 202 generates labels for a first set of physician training examples, the data preprocessing module 204 may generate features and associate the labels generated by the label generation module 202 with those features, as discussed above. The data preprocessing module 204 may then determine feature values for a second set of physician training examples for which the label generation module 202 is not able to readily generate labels. The taxonomy clustering module 206 may then utilize a clustering algorithm to determine clusters of training examples from among the first and second sets of training examples (e.g., K-nearest neighbors). For any unlabeled training examples that are clustered together with a labeled training example, the taxonomy clustering module 206 may assign the label from the labeled training example to the unlabeled training examples.

In one example, the taxonomy clustering module 206 may determine a similarity metric between each unlabeled training example and each labeled training example based on the feature values associated with the training examples (e.g., using least-squared error). Then, if the similarity metric between a labeled training example and an unlabeled training example is greater than a predetermined threshold, the taxonomy clustering module 206 may assign the label from the labeled training example to the unlabeled training example. If an unlabeled training example has a similarity metric greater than the threshold for multiple labeled training examples, the taxonomy clustering module 206 may assign the label from the labeled training example having the highest similarity metric with the unlabeled training example. As such, additional ground truth labels can be created for training examples associated with physicians who have similar profiles to other physicians with taxonomy labels that were determined by the label generation module 202. This may increase the amount of training data that may be used to train the model.

Referring still to FIG. 2, the model training module 208 may train the model maintained by the computing device 100, as disclosed herein. As an initial step, the model training module 208 may segregate the labeled training examples, determined by the label generation module 202, the data preprocessing module 204, and the taxonomy clustering module 206 as described above, into training data, validation data, and test data. In one example, the model training module 208 may use 80% of the training examples as training data, 10% of the training examples as validation data, and 10% of the training examples as test data. However, in other examples, other allocations of training examples may be used. The training data may be used to directly train the model and the validation and test data may be used to validate and test the trained model to prevent overfitting of the model to the training data, as disclosed in further detail below.

In embodiments, the model training module 208 may train the model to receive feature values associated with a physician as input and output a predicted taxonomy for the physician. In particular, the model may be a classifier trained to classify a physician into one of a plurality of potential taxonomies based on the input feature values associated with the physician. In embodiments, the model may comprise a variety of types of classifier such as logistic regression, deep neural network, gradient boosting machine, or random forest. In some examples, the model training module 208 may train multiple different models based on the training data and the best performing model may be selected, as discussed below.

In examples where the model uses a deep neural network as a classifier, more labeled data may be needed to properly train the model than is typically available using the methods discussed above. Thus, in these examples, transfer learning using a stacked autoencoder (SA) may be used. In particular, an SA may first be trained on unlabeled data (which is readily available) to learn the low-level features of the classifier. A number of fully connected layers may then be added to the SA to obtain a unified model. The top layer of the fully connected layers may have a number of perceptrons equal to the number of potential taxonomy to which a physician may be classified. Each perceptron may have an activation function (e.g., a sigmoid activation function) and each perceptron may output a percentage likelihood that a physician is associated with the taxonomy associated with the perceptron based on the data input to the model. The parameters from the SA that have already been trained may then remain constant while the available labeled data may be used to train the newly added layers. Once the newly added layers converge, all of the layers, including the SA layers and the additional layers, may then be trained using the labeled data. This may allow for a better trained deep neural network than if were trained using only the available labeled data.

For each model to be trained (e.g., logistic regression, deep neural network, gradient boosting machine, random forest), the model training module 208 may use known machine learning techniques to train each model. For example, the model training module 208 may initially assign random weights to the model parameters and determine an output of the model for each training example. A loss function may then be calculated based on a difference between the outputs of the model for the training examples and the ground truth values. The model parameters may then be updated using any optimization method to reduce the loss function until it converges to a minimum value. After the loss function is minimized, the learned parameters of the model may be stored in the data storage component 108. In examples where multiple models are trained, the model training module 208 may separately train each model based on the training data. After a model is trained, it may receive input features values associated with a physician and may output probability values indicating a predicted likelihood that the physician is associated with particular taxonomies.

Referring still to FIG. 2, the hyperparameter tuning module 210 may tune the hyperparameters of each of the models trained by the model training module 208. In addition to the parameters of a model learned during training, the performance of a model can also be significantly affected by the hyperparameters associated with the model. Accordingly, the hyperparameter tuning module 210 may tune the hyperparameters of a model trained by the model training module 208 to optimize performance of the model.

In embodiments, the hyperparameter tuning module 210 tunes the hyperparameters based on the validation data generated by the data preprocessing module 204, as discussed above. In particular, after the model training module 208 trains a model based on the training data prepared by the data preprocessing module 204, the hyperparameter tuning module 210 inputs the training examples of the validation data into the trained model and determines a loss function based on the output of the model for each of the training examples and the ground truth values associated with the validation data. The hyperparameter tuning module 210 may then adjust one or more hyperparameters of the model to reduce the loss function associated with the validation data. This may prevent the model from overfitting or underfitting to the training data.

In some examples, the hyperparameter tuning module 210 may utilize the GridSearchCV algorithm to determine optimal hyperparameters. In other examples, the hyperparameter tuning module 210 may utilize other method or algorithms to tune the hyperparameters associated with a model. The hyperparameter tuning module 210 may tune any number of hyperparameters for model. For example, for a Random Forest model, two hyperparameters to be tuned may include the minimum number of samples required to split an internal node and the minimum number of samples required to be at a leaf node. In a deep neural network, the number of hidden layers and the number of nodes per layer may be tuned. However, in other examples, other hyperparameters may be tuned. In the illustrated example, the hyperparameter tuning module 210 may perform hyperparameter tuning of each model trained by the model training module 208.

Referring back to FIG. 2, the model testing module 212 may test each model trained by the model training module 208 using the training data prepared by the data preprocessing module 204, as discussed above. As discussed above, the training data prepared by the data preprocessing module 204 may be used to train a model and the validation data prepared by the data preprocessing module 204 may be used to tune the hyperparameters of a model. Thus, after a model is trained and its hyperparameters are tuned, the model may be tested by inputting the examples from the test data into the trained model, and comparing the output of the model for each example to the ground truth values associated with the test data examples.

The model testing module 212 may determine how well a model performs within each label based on the test data and the ground truth label associated with the test data. In some examples, the model testing module 212 may determine a validation score based on how well the output of the model matches the ground truth values for the test data. In one example, the model testing module 212 may determine an F-score for each taxonomy output by the model as a measure of how well the model performs. However, in other examples, other methods of measuring the performance of the model may be used.

If the performance of the model is satisfactory (e.g., if the F-scores are each above a predetermined threshold value), then the model may be deployed on unlabeled data as described below. If the model performance is not satisfactory (e.g, certain F-scores are below a threshold value), then the model may be further investigated to improve its performance. For example, the type of data input to the model may be adjusted, the training method (e.g., the optimization method) used to train may be adjusted, the hyperparameters of the model may be tuned or adjusted, or different types of models may be used.

Referring still to FIG. 2, the model selection module 214 may select a model to be deployed in examples where multiple models are trained by the model training module 208. For example, as discussed above, the model training module 208 may train models based on logistic regression, neural network, gradient boosting machines, and random forest, among others. In these examples, the model testing module 212 may test each trained model based on the test data (e.g., by determining F-scores associated with the taxonomies of each model). The model selection module 214 may then select the model having the best performance (e.g., the model with the highest F-scores) to be deployed. In examples where a single model is trained by the model training module 208, the model selection module 214 may be omitted from the memory modules 106.

Referring still to FIG. 2, the taxonomy classification module 216 may be used to classify a physician into a particular taxonomy based on unlabeled data associated with the physician. In particular, the taxonomy classification module 216 may utilize the model selected by the model selection module 214, as discussed above, to determine a taxonomy classification for a physician.

After the model training module 208 trains one or more models based on training data, and the model selection module 214 selects the best performing model, the selected model may be used by the taxonomy classification module 216, as disclosed herein. For a physician whose taxonomy is to be determined, the data retrieval module 200 may retrieve data associated with the physician, as discussed above. In particular, the data retrieval module 200 may retrieve data associated with procedures performed by the physician. In some examples, the data retrieval module 200 may retrieve other types of data associated with the physician (e.g., how the physician self-identifies).

After the data retrieval module 200 receives data associated with the physician, the data preprocessing module 204 may preprocess the data, as discussed above. In particular, the data preprocessing module 204 may convert the data associated with the physician, received by the data retrieval module 200, into a fixed length input sequence of feature values, as discussed above. The taxonomy classification module 216 may then input the feature values generated by the data preprocessing module 204 into the model selected by the model selection module 214. Then, for each potential taxonomy, the model may output a probability that the physician is associated with that taxonomy. The taxonomy classification module 216 may select the taxonomy having the highest probability as the taxonomy to classify the physician into.

In some examples, the model may comprise two stages. In a first stage, the model may output a probability that the physician is associated with different specialties or classes. In the second stage, the model may output a probability that the physician is associated with a sub-specialty or taxonomy within a particular class. In these examples, the first stage and the second stage of the model may be trained separately by the model training module 208. In particular, after the first stage of the model is trained, a set of second stage models may be trained for each class that may be output by the first stage model. For example, if the first stage is trained to classify a physician into one of 15 classes, then 15 separate second stage models may be separately trained by the model training module 208. The training data used to train each second stage model may only comprise training examples for physicians within the particular class associated with the particular second stage model being trained.

After the first stage model and the plurality of second stage models are trained by the model training module 208, the taxonomy classification module 216 may input the preprocessed data associated with a physician to be classified into the first stage model. The first stage model may output a probability that the physician is associated with each potential class, and the taxonomy classification module 216 may select the class having the highest probability as the class within which to classify the physician. The taxonomy classification module 216 may then identify the second stage model associated with the selected class, and input the preprocessed data into the identified second stage model. The second stage model may then output a probability that the physician is associated with each taxonomy within the identified class. The taxonomy classification module 216 may then select the taxonomy having the highest probability as the taxonomy within which to classify the physician.

In the illustrated example, the taxonomy classification module 216 classifies a physician into a single taxonomy (e.g., the taxonomy that the trained model indicates has the highest probability of being associated with the physician). However, in other examples, the taxonomy classification module 216 may classify a physician into multiple taxonomies. For example, the taxonomy classification module 216 may select each taxonomy for which the probability output by the trained model is above a predetermined threshold amount (e.g., above 10%). The taxonomy classification module 216 may then classify the physician into each taxonomy that meets this criteria.

In some examples, the taxonomy classification module 216 may determine a confidence level of a classification of a physician. As discussed above, the taxonomy classification module 216 may classify a physician into the taxonomy having the highest probability output by the trained model. In some examples, the taxonomy classification module 216 may determine a confidence level of the classification based on the probability output by the model for that taxonomy. That is, the higher the probability value output by the trained model, the higher the confidence level may be determined by the taxonomy classification module 216.

Referring still to FIG. 2, the taxonomy sampling module 218 may randomly sample certain taxonomy classifications determined by the taxonomy classification module 216 such that their accuracy may be independently validated. Validation of taxonomy classifications made by the trained model may ensure the propriety of the trained model. However, validating each classification made by the model may be overly time consuming. As such, the taxonomy sampling module 218 may sample a small number of classifications made by the model for validation. In particular, the taxonomy sampling module 218 may randomly select a predetermined number of classifications made by the taxonomy sampling module 218, along with the physician data used by the model to make the classifications. The sampled taxonomy classifications may then be validated, as disclosed herein.

In one example, the classifications made by the taxonomy sampling module 218 may be presented to subject matter experts who may determine whether a classification makes sense based on the physician data. In other examples, users of the computing device 100 may provide feedback as to how well the classifier is working. For example, users may flag a particular classification if they feel it is wrong. These various types of feedback may be used to refine the model to increase its accuracy.

Referring still to FIG. 2, the model interpretation module 220 may interpret the trained model, as disclosed herein. Machine learning models often operate like black boxes, wherein after a model is trained, it is difficult to identify which factors influence the behavior of the model. This can make their acceptance by the general public less forthcoming, in particular in areas such as health care. As such, if a trained model is simply presented to physicians, insurance providers, or others as a black box, they may be less likely to accept it as providing accurate classifications. As such, the model interpretation module 220 may provide additional insights into how a trained model operates.

In embodiments, the model interpretation module 220 may provide two types of insights with respect to a trained model. In a first example, for a given taxonomy, the model interpretation module 220 may indicate which features most strongly correlate to that taxonomy being selected. In a second example, for a taxonomy selected for a particular physician, the model interpretation module 220 may indicate which data associated with that physician were most influential in the particular taxonomy being selected. In the illustrated example, the model interpretation module 220 uses Shapley Additive Explanations (SHAP) to make these determinations. However, in other examples, other methods may be used to make these determinations.

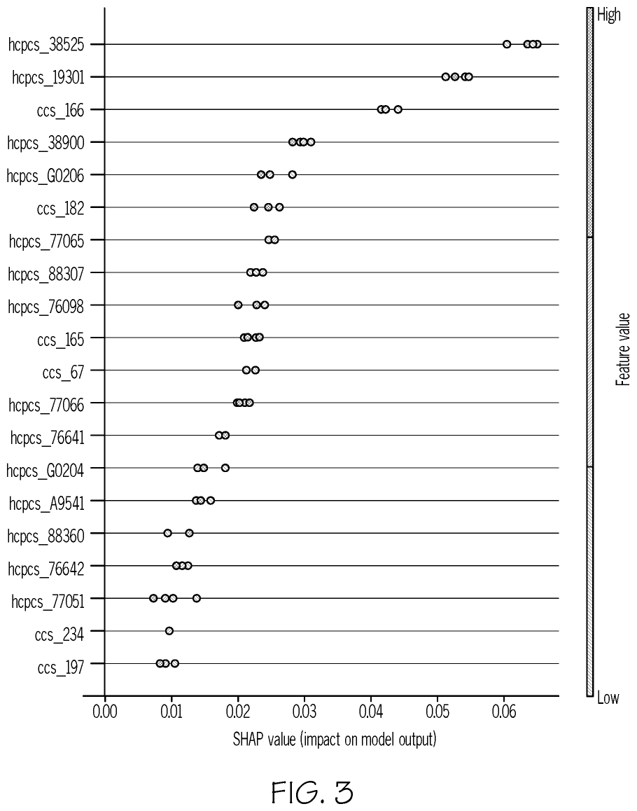

FIG. 3 shows an example of the first type of output that may be generated by the model interpretation module 220 with respect to a specific taxonomy. As shown in FIG. 3, a SHAP value (indicating an impact on the model output) is shown for a plurality of features (HCPCS and CCS codes in the example of FIG. 3). In the example of FIG. 3, procedure code hcpcs_38525 has the largest impact on this particular taxonomy being selected, procedure code hcpcs_19301 has the second largest impact on this taxonomy being selected, and so on. This type of information can provide confidence to users that the types of procedures which cause certain taxonomies to be selected make sense.

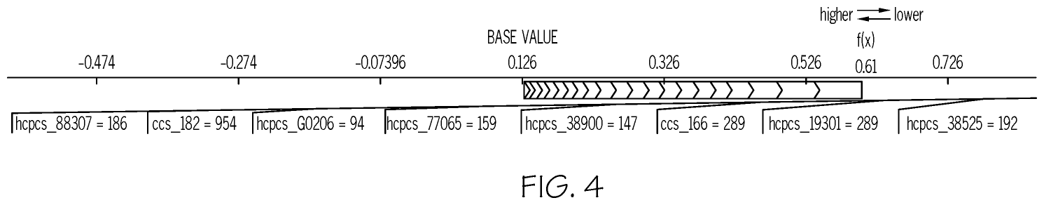

FIG. 4 shows an example of the second type of output that may be generated by the model interpretation module 220 with respect to a particular physician. In particular, the example of FIG. 4 indicates what features were the biggest cause of the physician being classified into the taxonomy output by the trained model. In the example of FIG. 4, the biggest driver of the physician's classification is that the physician performed procedure hcpcs_38525 192 times. The second biggest driver of the classification is that the physician performed procedure hcpcs_19301 289 times. This type of information can similarly indicate why a physician was classified in a certain way, thereby providing confidence in the classification function of the model.

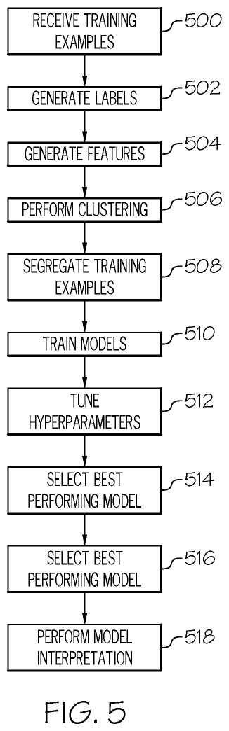

FIG. 5 depicts a flowchart of an example method that may be performed by the computing device 100 to train a model to classify a physician taxonomy. At step 500, the data retrieval module 200 receives training data comprising a plurality of training examples. Each training example may be associated with a different physician and may contain data associated with the physician. In the illustrated example, each training example may include data about medical procedures performed by the physician (e.g., billing codes). Training examples may also include other data about the physician (e.g., self-identified taxonomies). The data retrieval module 200 may retrieve the data from a variety of data sources including billing records from Medicare, Medicaid, or insurance companies, hospital records, commercial websites, and the like.

At step 502, the label generation module 202 generate labels associated with certain training examples. In particular, the label generation module 202 may generate labels for training examples associated with physicians for which reliable taxonomy information is available. A label for a training example may indicate a taxonomy for a particular physician. In some examples, the data retrieval module 200 may receive labels associated with certain physicians (e.g., from medical societies that provide reliable taxonomy information). In some examples, a panel of experts may determine a taxonomy for certain physicians. In other examples, the label generation module 202 may utilize other techniques to assign labels to training examples.

At step 504, the data preprocessing module 204 preprocesses the data received by the data retrieval module 200 to generate features that may be input to a model. In the illustrated example, the data preprocessing module 204 may generate a fixed length sequence of feature values for each training example received by the data retrieval module 200. In the illustrated example, the features may include a number of times that each procedure among a plurality of procedures have been performed by the physician within a predetermined time period. In some examples, the data preprocessing module 204 may also generate features based on other data received by the data retrieval module 200.

At step 506, the taxonomy clustering model performs unsupervised learning techniques such as clustering algorithms to generate labels for additional data for training examples for which the label generation module 202 cannot readily generate labels. In particular, the taxonomy clustering may determine a similarity metric (e.g., a distance vector in feature space) between unlabeled training examples and labeled training examples (e.g., training examples that have been labeled by the label generation module 202). If certain unlabeled training examples are sufficiently similar (e.g., part of the same cluster) as a labeled training example, the taxonomy clustering module 206 may label the unlabeled examples in the cluster with the same label as the labeled training example of the cluster.

At step 508, the data preprocessing module 204 may segregate the labeled training examples (e.g., training examples labeled by the label generation module 202 and/or the taxonomy clustering module 206, as discussed above) into training data, validation data, and test data. In the illustrated example, the data preprocessing module 204 may select 80% of the training examples as training data, 10% of the training examples of the validation data, and 10% of the training examples as test data. However, in other examples, any other allocation of training examples into training data, validation data, and test data may be used.

At step 510, the model training module 208 trains one or more models maintained by the computing device 100. The computing device 100 may maintain a variety of different machine learning models, and the model training module 208 may utilize a variety of machine learning techniques to train the models. In the illustrated example, the model training module 208 may maintain models based on logistic regression, neural networks, gradient boosting machines, and random forest architectures. However, in other examples, the model training module 208 may maintain other types of models. The model training module 208 may train each model maintained by the computing device 100 such that model parameters are learned so as to minimize a loss function based on a difference between the model output when training data is input, and ground truth labels. After a model is trained, the learned parameters of the model may be stored by the data storage component 108.

At step 512, the hyperparameter tuning module 210 tunes the hyperparameters of the models maintained by the computing device 100. In particular, the hyperparameter tuning module 210 may utilize the validation data, as determined by the data preprocessing module 204, to tune the hyperparameters of the models after the models have been trained by the model training module 208.

At step 514, the model testing module 212 tests each of the models trained by the model training module 208 using the test data identified by the data preprocessing module 204. In particular, the model testing module 212 may determine how well the taxonomies predicted by the trained models for the training examples of the test data compare to the ground truth taxonomy labels of the test data training examples. In some examples, the model testing module 212 may determine F-scores for each of the taxonomies output by the trained models based on the test data.

At step 516, the model selection module 214 selects the best performing model among the models trained by the model training module 208. In particular, the model selection module 214 may select the best performing model based on the testing performed by the model testing module 212. The model selected by the model selection module 214 may then be used to classify physicians based on unlabeled data.

At step 518, the model interpretation module 220 performs an interpretation of the model selected by the model selection module 214. In particular, the model interpretation module 220 may identify which input features are most correlated with each potential taxonomy. In the illustrated example, the model interpretation module 220 interprets the model using SHAP. However, in other examples, other methods may be used to interpret the model.

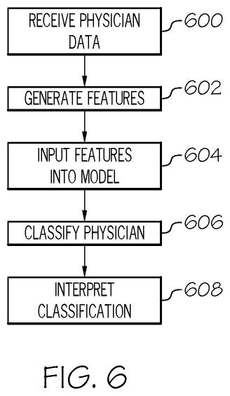

FIG. 6 depicts a flowchart of an example method of using a trained model maintained by the computing device 100 to classify a physician into a taxonomy based on data associated with the physician. At step 600, receive physician data

At step 602, the data retrieval module 200 receives data associated with a physician to be classified into a taxonomy. At step 604, the data preprocessing module 204 generates features based on the data received by the data retrieval module 200, as described above. At step 604, the taxonomy classification module 216 inputs the features generated by the data preprocessing module 204 into the trained model selected by the model selection module 214.

At step 606, the taxonomy classification module 216 selects a taxonomy to classify the physician based on an output of the model. As discussed above, when features associated with a physician are input into the trained model, the model outputs a probability value for each potential taxonomy, indicating a predicted likelihood that the physician should be classified into that taxonomy. As such, the taxonomy classification module 216 may select the taxonomy having the highest probability value output by the model to classify the physician into.

At step 608, the model interpretation module 220 interprets the classification selected by the taxonomy classification module 216. In particular, the model interpretation module 220 may identify the data associated with the physician that had the largest effect on the selected taxonomy. In the illustrated example, the model interpretation module 220 uses SHAP to interpret the classification, as discussed above. However, in other examples, other methods may be used to classify the selected taxonomy.

It should now be understood that embodiments described herein are directed to physician subspecialty taxonomy using data-driven models. In embodiments described herein, a model may be trained to receive data associated with a physician and output a predicted taxonomy classification for the physician. A plurality of models may be trained using training data comprising physician data. The training data may be preprocessed to extract features from the data and ground truth labels may be assigned to the training data when ground truth labels are readily available. When ground truth labels are not readily available, unsupervised learning techniques (e.g., clustering algorithms) may be used to generate additional ground truth labels.

Once labels have been assigned to training examples, the training examples may be divided into training data, validation data, and test data. A plurality of models may be trained using the training data, and hyperparameters of the models may be tuned using the validation data. After the models are trained and the hyperparameters are tuned, the test data may be used to test each of the trained models, and the best performing model may be selected for deployment. The deployed model may then be used to classify physicians into a particular taxonomy based on data associated with the physician.

Accordingly, the embodiments described herein overcome the technical challenges of receiving a large variety of disparate data, extracting appropriate features from the data, training a model to predict physician taxonomy, and selecting a suitable model. The physician taxonomies output by the model may be used in a variety of applications such as selecting appropriate physicians for needed health care by customers, selecting physicians for a network by an insurance company, or for other physicians to make appropriate referrals.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving data associated with a plurality of physicians;
extracting features from the data to determine a plurality of training examples, each training example being associated with a different physician;
determining ground truth labels for one or more of the training examples to generate a plurality of labeled training examples, each ground truth label comprising a taxonomy associated with a physician;
segregating the plurality of labeled training examples into training data, validation data, and test data;
training a machine learning model to predict a taxonomy associated with a physician based on the training data; and
tuning hyperparameters of the model based on the validation data.

2. The method of claim 1, wherein the model comprises a random forest architecture.

3. The method of claim 1, wherein the model comprises a deep neural network.

4. The method of claim 1, wherein:
the data associated with the plurality of physicians comprises data about different medical procedures performed by the physicians; and
extracting features from the data comprises determining a number of times that each of the physicians has performed each of the different medical procedures with a predetermined time period.

5. The method of claim 1, further comprising:
training a plurality of models to predict a taxonomy associated with a physician based on the training data;
testing a performance of each of the models based on the test data; and
selecting the model having the best performance among the plurality of models.

6. The method of claim 5, further comprising:
testing the performance of each of the models by determining F-scores associated with outputs of each of the models.

7. The method of claim 1, further comprising:
training the model to determine a confidence level of the predicted taxonomy.

8. The method of claim 1, further comprising:
training a first stage of the model to predict a specialty associated with a physician based on the training data; and
training a second stage of the model to predict a taxonomy within the specialty associated with the physician based on the training data.

9. The method of claim 1, wherein training the model comprises:
training a stacked autoencoder using unlabeled data;
adding a plurality of fully connected layers to the stacked autoencoder;
after training the stacked autoencoder, training the fully connected layers based on the training data; and
after training the fully connected layers, training the model comprising the stacked autoencoder and the fully connected layers based on the training data.

10. The method of claim 1, further comprising:
using unsupervised learning techniques to determine a similarity between unlabeled training examples and the labeled training examples based on the features of the labeled training examples and the features of the unlabeled training examples;
determining ground truth labels for one or more of the unlabeled training examples based on the similarity to generate supplemental labeled training examples;
combining the labeled training examples and the supplemental labeled training examples to generate expanded labeled training examples; and
segregating the expanded labeled training examples into training data, validation data, and test data.

11. The method of claim 1, further comprising:
determining a relative amount that one or more of the features contribute to one or more taxonomies output by the model using Shapley Additive Explanations.

12. The method of claim 1, further comprising:
receiving unlabeled data associated with a target physician;
extracting target features from the unlabeled data;
inputting the target features into the trained model; and
assigning a taxonomy to the target physician based on the trained model.

13. The method of claim 12, wherein:
the trained model outputs a probability value that the target physician is associated with each of a plurality of taxonomies; and
assigning the taxonomy to the target physician comprises selecting the taxonomy having the highest probability value output by the trained model.

14. The method of claim 12, further comprising:
determining a relative amount that one or more of the target features contribute to the taxonomy assigned to the target physician using Shapley Additive Explanations.

15. An apparatus comprising a controller programmed to:
receive data associated with a plurality of physicians;
extract features from the data to determine a plurality of training examples, each training example being associated with a different physician;
determine ground truth labels for one or more of the training examples to generate a plurality of labeled training examples, each ground truth label comprising a taxonomy associated with a physician;
segregate the plurality of labeled training examples into training data, validation data, and test data;
train a machine learning model to predict a taxonomy associated with a physician based on the training data; and
tune hyperparameters of the model based on the validation data.

16. The apparatus of claim 15, wherein:
the data associated with the plurality of physicians comprises data about different medical procedures performed by the physicians; and
the controller is configured to extract the features from the data comprises determining a number of times that each of the physicians has performed each of the different medical procedures with a predetermined time period.

17. The apparatus of claim 15, wherein the controller is further programmed to:
train a plurality of models to predict a taxonomy associated with a physician based on the training data;
test a performance of each of the models based on the test data; and
select the model having the best performance among the plurality of models.

18. The apparatus of claim 15, wherein the controller is further programmed to:
train a first stage of the model to predict a specialty associated with a physician based on the training data; and
train a second stage of the model to predict a taxonomy within the specialty associated with the physician based on the training data.

19. The apparatus of claim 15, wherein the apparatus is further programmed to:
use unsupervised learning techniques to determine a similarity between unlabeled training examples and the labeled training examples based on the features of the labeled training examples and the features of the unlabeled training examples;
determine ground truth labels for one or more of the unlabeled training examples based on the similarity to generate supplemental labeled training examples;
combine the labeled training examples and the supplemental labeled training examples to generate expanded labeled training examples; and
segregate the expanded labeled training examples into training data, validation data, and test data.

20. The apparatus of claim 15, wherein the controller is further programmed to:
receive unlabeled data associated with a target physician;
extract target features from the unlabeled data;
input the target features into the trained model; and
assign a taxonomy to the target physician based on the trained model.
